(19) United States
(12) Patent Application Publication
(10) Pub. No.: US 2010/0175303 A1
(43) Pub. Date: Jul. 15, 2010

(54) FISHING DEVICES AND METHODS OF USE AND MANUFACTURE THEREOF

(76) Inventor: Darren Caison, Fort Washington, MD (US)

Correspondence Address: FISH & RICHARDSON P.C., P.O. BOX 1022, MINNEAPOLIS, MN, 55440-1022, US

(21) Appl. No.: 12/684,416

(22) Filed: Jan. 8, 2010

Related U.S. Application Data
(60) Provisional application No. 61/143,369, filed on Jan. 8, 2009.

(51) Int. Cl. A01K 99/00; A01K 91/03

(52) U.S. Cl. 43/4.5; 43/43.15

(57) ABSTRACT

A device for fishing in a body of water includes a first generally extended member having a first end and second end, a second member including a generally resilient material having a first portion connected with the first member and a second portion operable with a second fishing attachment, and a sleeve slidably operable with the first member and the second member to retain the second member disposed proximate and generally in alignment with the first member. A method of making a fishing rig includes forming a loop in a medial portion of a first generally resilient wire member, and securing a first end of a second generally resilient wire member to the first member proximate the loop, wherein the second member depends from the loop, and a first end and a second end of the first member are disposed spaced from one another and spaced from the second member.

### CROSS-REFERENCE TO RELATED APPLICATIONS

This application claims priority to U.S. Provisional Application No. 61/143,369, filed on Jan. 8, 2009 and is incorporated herein.

### TECHNICAL FIELD

This disclosure relates to fishing devices, systems, and methods.

### BACKGROUND

Like many outdoor sports, angling is a pastime enjoyed by many individuals. Typically, an angler selects from among various pieces of equipment specifically designed to attract and catch one or more selected specie(s) of fish. Accordingly, anglers may obtain, store, and transport many different pieces of equipment for use in attracting and catching different species of fish, such as species of fish having different patterns of behavior. For certain fish species, a piece of angling equipment may include many different components with a specific arrangement and configuration that is designed to facilitate a preferred presentation of bait or lure, provide supplemental or alternative attractants, or the like.

For anglers, however, a source of frustration may be encountered when their equipment performs inadequately. Among other reasons, angling equipment may not perform as expected or desired due to tangles and/or snags of the equipment. Particularly, during use, hooks frequently become entangled with debris or with other pieces of equipment with which the hook is used, such as leaders, fishing line, weights, or the like. Thus, reducing snags and tangles is beneficial for improved angling. Particularly where equipment has multiple components, the opportunity for encountering tangles may be increased, causing reduced performance and increased frustration among users.

Another source of frustration may be encountered when storing and/or transporting angling equipment. In such circumstances, angling equipment may similarly become tangled with other pieces of equipment, or with other components of the equipment. Additionally, storage and transportation of angling equipment may be inconvenient due to the size and configuration of the equipment. Accordingly, an angler may wish to reduce a size necessary to store and transport a piece of equipment. Doing so, however, may increase a likelihood of the equipment becoming tangled due to the close proximity of different components, such as hooks.

Accordingly, there is a need for angling equipment adapted to reduce snags and/or tangles during use. Additionally, there is a need for angling equipment that may conveniently be stored and transported.

### SUMMARY

In a first aspect, a device for fishing in a body of water includes a first generally extended member having a first end and a second end, the second end operable with a first attachment, a second member comprising a generally resilient material having a first portion connected with the first member and a second portion operable with a second fishing attachment, the second member being biased in a position angularly disposed relative to the first member, and a sleeve slidably operable with the first member and the second member to retain the second member disposed proximate and generally in alignment with the first member.

The device may include one or more additional features. For example, the second member may include a first end, a second end, and a medial portion, the second end being biased in a position angularly disposed relative to the first member and adapted to be retained proximate and generally in alignment with the first member by the sleeve. The medial portion may include a loop formed in the second member, and the second member may be connected with the first member proximate the loop and proximate the first end of the first member. Additionally, a distance from the medial portion to the first end of the second member may be unequal to a distance from the medial portion to the second end of the second member. The device may include the second fishing attachment, and the second fishing attachment may be operable with the second member such that the second fishing attachment is prevented from engaging the first member when the second member is in the position angularly disposed relative to the first member. Furthermore, the first member may include a joint at a proximal portion thereof and the first member may be operable to fold about the joint.

In another aspect, a fishing rig includes a first wire member having a first end and a second end, at least one arm connected to the first member proximate the first end of the first member, and a sleeve disposed around the first wire member. The at least one arm is adapted to receive a fishing implement on a distal end thereof and is collapsible for storage. The distal end is spaced from the first member when the arm is not collapsed, and when the arm is collapsed, the sleeve is disposed around the arm to retain the arm in a collapsed position.

The device may include one or more additional features. For example, the at least one arm may include a first portion and a second portion, and the first portion may have a length unequal to a length of the second portion. Additionally, the first wire member may include a medial hinge.

In another aspect, a method of making a fishing rig includes forming a loop in a medial portion of a first generally resilient wire member and securing a first end of a second generally resilient wire member to the first member proximate the loop such that the second member depends from the loop, and such that a first end and a second end of the first member are spaced from one another and spaced from the second member.

The method may include one or more additional features, For example, the method may include hingedly securing a third member to the second member proximate a second end of the second member. The method may include disposing a sleeve surrounding the first member and the second member. Additionally, the disposing may include sliding the sleeve over the first end and the second end of the first member, and bending the first member to dispose the first end and the second end spaced from one another after the sliding.

In another aspect, a method of using a fishing rig having at least one collapsible arm secured to and extending generally laterally from a first member includes collapsing the at least one collapsible arm to dispose the at least one arm proximate and generally parallel to the first member, and sliding a collar over the at least one collapsible arm to retain the at least one collapsible arm proximate and generally parallel to the first member.

The method may include one or more additional features, For example, the method may include releasing the at least one collapsible arm from proximate and generally parallel to the first member by sliding the collar over the at least one collapsible arm.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a front elevation of an exemplary fishing rig.

FIG. 1a is a front elevation of the fishing rig of FIG. 1 in a second configuration.

FIGS. 2-6 are front elevation views of alternative implementations of a fishing rig.

Like reference symbols in the various figures indicate like elements.

### DETAILED DESCRIPTION

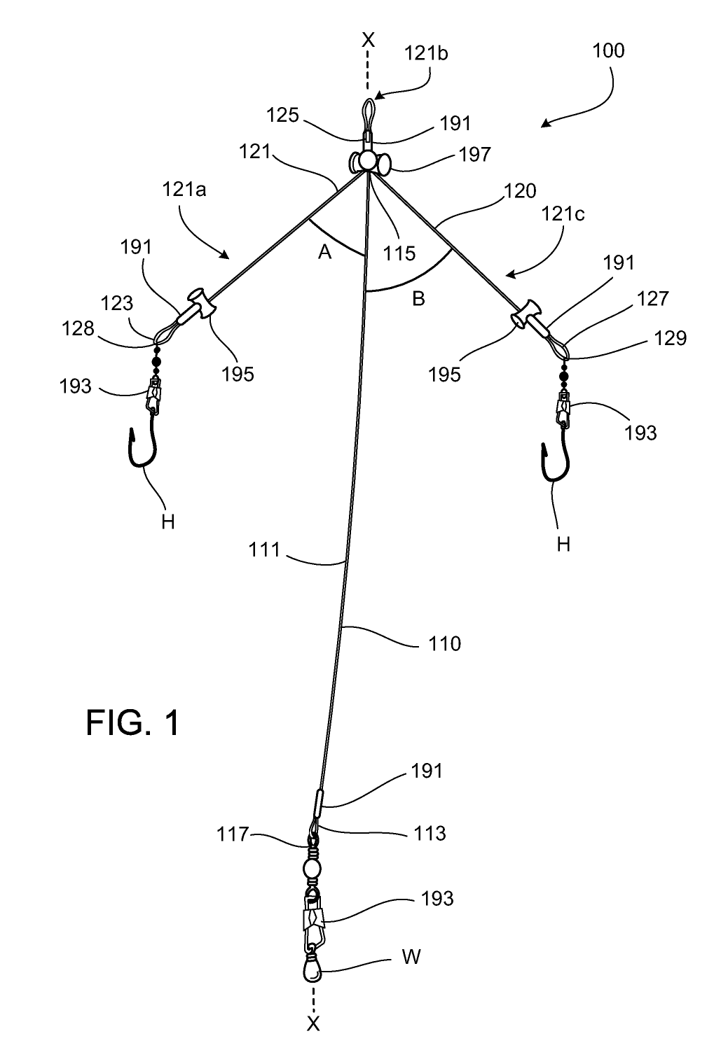

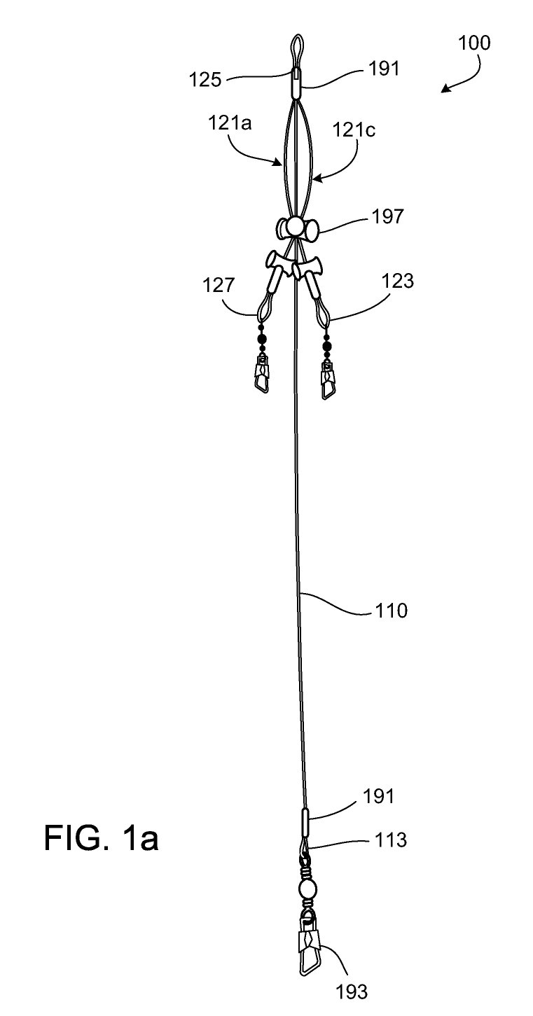

FIG. 1 illustrates a fishing device, for example, a fishing rig 100, that may be used in combination with, for example, a fishing rod, reel, line, weight, float, hook, bait, lure, attractant, and/or other angling equipment for attracting and catching one or more selected fish specie(s). Specifically, the rig 100 includes a first generally resilient member 110 and a second generally resilient member 120 engaged therewith. One or both of the first member 110 and the second member 120 may be formed from a resilient wire, such as a stainless steel leader wire. Alternatively, the first member 110 and/or the second member 120 may be formed from other materials, including other metals, plastics, and combinations thereof.

The first member 110 includes a segment 111 having a first end 113 and a second end 115, and is generally arranged along a first linear axis (X-X). The first end 113 of the first member 110 includes a loop 117 secured by a sleeve 191 crimped therearound. The loop 117 may, however, be secured by alternative devices, such as one or more tie(s), strap(s), wrapped wire(s), adhesive(s), welding, or the like. A first attachment, for example a fishing weight W, is operable with the first end 113 to provide desired mass, such as to assist in sinking the rig 100 during use. Additionally, another attachment, such as a swivel hook 193 is engaged with the loop 117, if desired, to facilitate engagement and disengagement of, for example, the weight W or other angling equipment or accessory, such as an attractant.

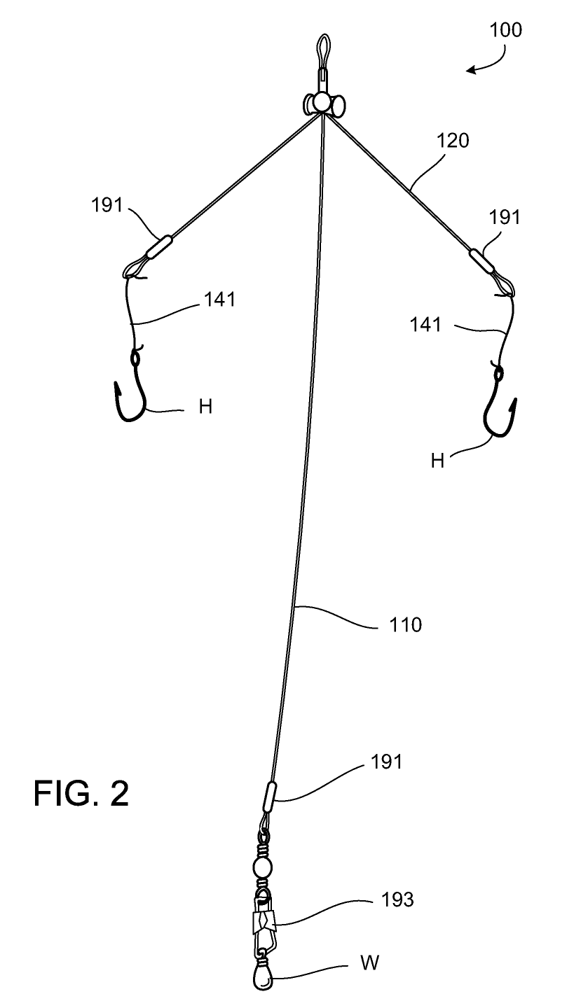

In the implementation illustrated in FIG. 1, the second end 115 of the first member 110 is secured to at least a portion of the second member 120. More specifically, the second member 120 includes a segment 121 having a first portion 121a, a second portion 121b, and a third portion 121c. The first portion 121a includes a first end 123 and extends from the first end 123 to a loop 125. Similarly the third portion 121c includes a second end 127 and extends from the second end 127 to the loop 125. Thus, the loop 125 is formed in the second portion 121b of the segment 121. The second member 120 may be joined to the first member 110 proximate to the loop 125 of the second portion 121b of the segment 121 by a crimped sleeve 191 disposed around the segment 121 and the second end 115 of the segment 111. One or both of the first end 123 and the second end 127 may include, for example, a respective loop 128, 129 secured by a respective sleeve 191, a respective swivel hook 193, and/or a respective accessory 195, such as a bead, a rattle, or other fish attractant. A hook H may be engaged with one or both of first end 123 and second end 127 by attachment to the swivel hooks 193. As shown in FIG. 2, swivel hooks 193 may be replaced by leaders 141, which may be formed from a natural or a synthetic material, such as a synthetic string.

Each of the first portion 121a and the third portion 121c extends away from the medial portion 121b at angles (A, B, respectively) relative to the first member 110, whereby the first end 123 and the second end 127 is each spaced laterally from the first member 110. Due to such spacing, an attachment, such as a hook H, operable therewith may be less likely to interact with, and potentially tangle with, the first member 110 and/or any accessories or other structures depending therefrom. Due, however, to a resilient nature of the second member 120, the first end 123 and/or the second end 127 may be disposed adjacent to the segment 111 of the first member 110, if desired, by application of an adequate collapsing force. When collapsed, the first portion 121a and/or the third portion 121c is/are disposed in a position and orientation generally parallel to and adjacent to the segment 111 of the first member 110, as illustrated in FIG. 1a. Such a configuration takes up less space when storing the rig 100 in, for example, a tackle box, and helps to limit tangles and snags while stored in the tackle box.

In order to maintain the rig 100 in such a storage configuration illustrated in FIG. 1a, and because the resilient nature of the second member 120 will cause return of the first end 123 and/or the second end 127 to the position spaced from the first member 110 (shown in FIG. 1) upon release of the collapsing force, a bead 197 surrounding the first member 110 and surrounding at least a portion of the second member 120 is provided. The bead 197 may be disposed, such as by sliding, in a position proximate to the first end 123 and/or the second end 127 to maintain the first end 123 and/or the second end 127 in a position proximate first member 110. Alternatively, the bead 197 may be engaged with the first end 123 and/or the second end 127 and the first member 110, for example by a snap-fit engagement, in which case sliding of the bead 197 may not be necessary. Additionally, the bead 197 may not completely surround the first end 123 and/or the second end 127 and the first member 110, but may partially surround the first end 123 and/or the second end 127 and the first member 110 such that they are captured by the bead 197, at least when the bead is engaged by the end 123 and/or the second end 127 and the first member 110.

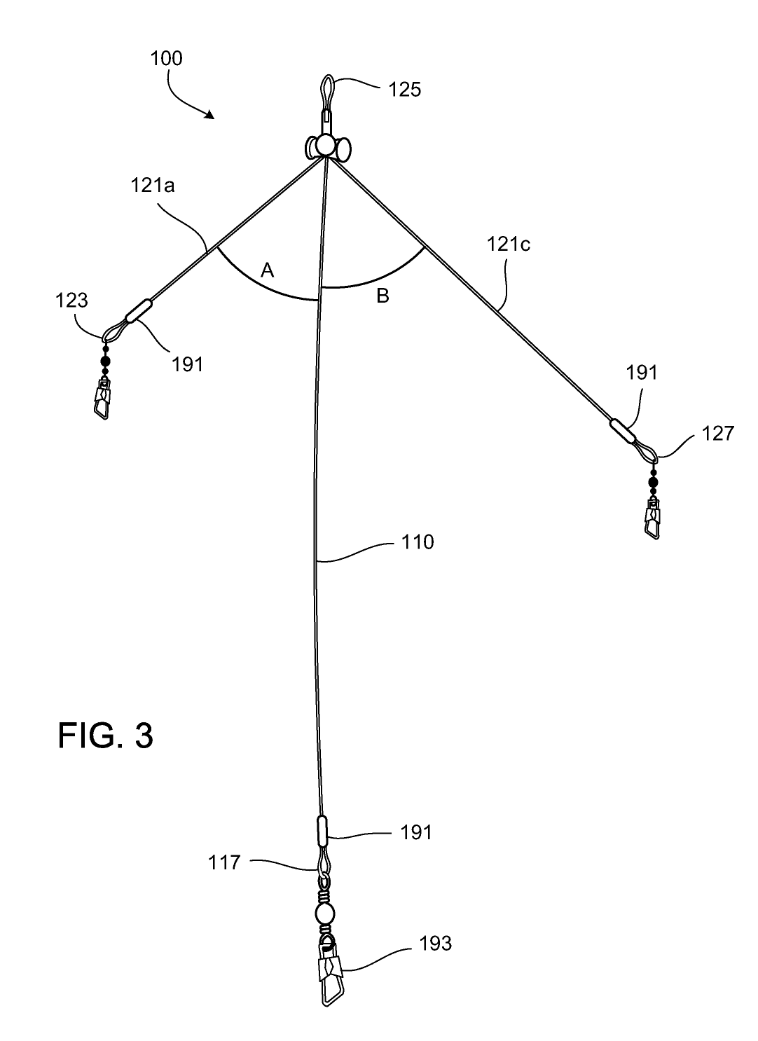

Now referring to FIG. 3, the first portion 121a of the segment 121 may have a different length than the third portion 121c of the segment 121. For example, first portion 121a may be shorter than third portion 121c, as shown in FIG. 3. In this configuration, the first end 123 is closer to the loop 125 than the second end 127. Alternatively, the first portion 121a may be longer than the third portion 121c, and therefore, the first end 123 is farther from the first end 113 of the first member 110 than is the second end 127. When the first portion 121a and the third portion 121c have different lengths, bait carried by the first end 123 and the second end 127 may be positioned at different positions during use. The different lengths of the first portion 121a and the second portion 121c may additionally cause the rig 100 to be unbalanced, whereby the longer third portion 121c tends to rotate to a lower position when the first member 110 is not aligned vertically during use. Alternatively, though, the rig 100 is not necessarily unbalanced due to the first portion 121a having a different length than the third portion 121c.

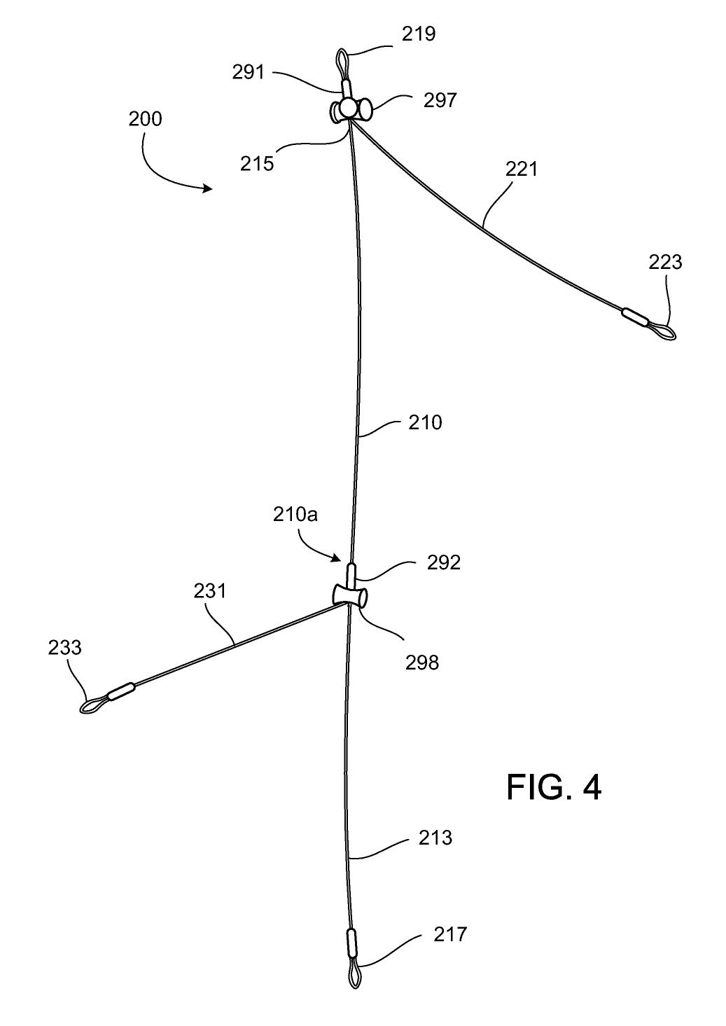

While the second member 120 has been described as a single segment 121, the second member 120 may, instead, include two or more segments 221 and 231, as shown in FIG. 4, each including a respective loop 223 and 233. More specifically, the rig 200 includes first member 210, which is similar to first member 110 of FIGS. 1-3, having a loop 217 formed at a first end 213. The second end 215 of the first member 210 includes a loop 219. The loop 219 is secured with a crimped sleeve 291. Additionally, the first segment 221 is engaged with the first end 215 of the first member 210 by the crimped sleeve 291. A bead 297 is included surrounding the first member 210 and the first segment 221. The second segment 231 is engaged with a medial portion 210a of first member 210, at a location between the first end 213 and the second end 215, by crimped sleeve 292. A bead 298 is included surrounding the medial portion 210a of the first member 210 and the second segment 231. Alternatively, the rig 200, as shown in FIG. 4, may be formed by replacing the portion of the first member 210 between the crimped sleeves 297 and 298 with a medial portion of the second member such that the second end 215 of the first member engages the second member at the crimped sleeve 298. As described above, the first segment 221 and the second segment 231 may be collapsed and retained in the collapsed position by the beads 297 and 298, respectively, for storage, and or transport of the rig assembly.

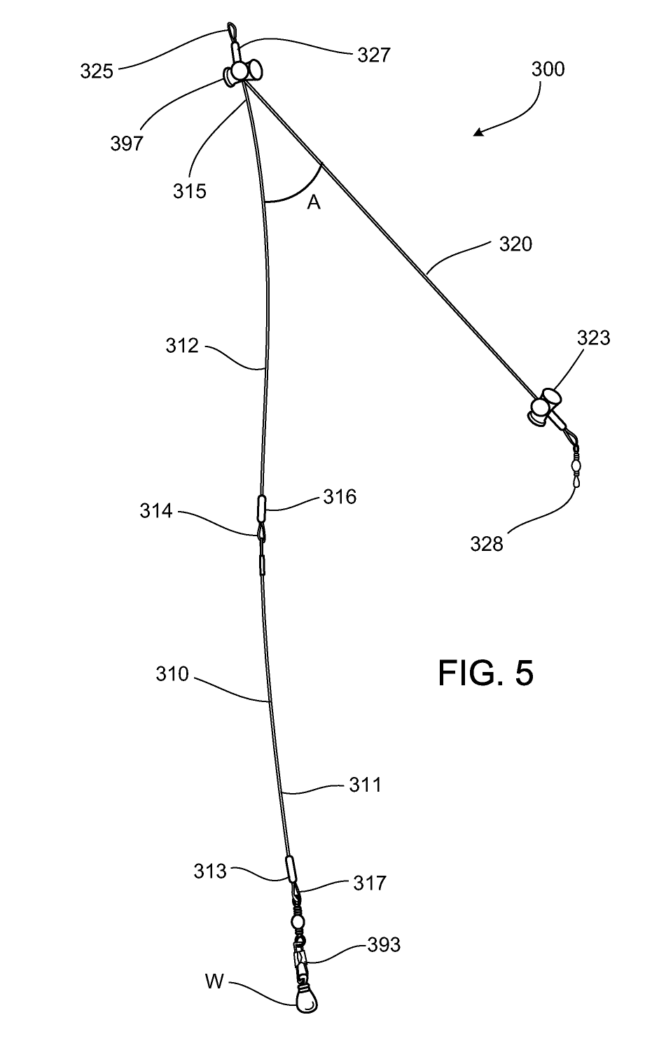

Now referring to FIG. 5, in another implementation, a rig 300 includes a first member 310 having a first segment 311 and a second segment 312, and a second member 320. The first member 310 has a loop 317 formed at first end 313. A weight W, or other attachment, is engaged with the first member 310 at the first end 313. First member 310 includes a second end 315 to which the second member 320 is engaged. Additionally, the first segment 311 engages the second member 312 by interlocking loops 314 and 316. The loops 314 and 316 provide a hinge and allow the first segment 311 to fold relative to the second segment 312. Thus, the length dimension of the first member 310 may be reduced for storage. The second member 320 includes a loop 328 at a first end 323 and a loop 325 at a second end 327. The second member 320 may be collapsed for storage, as described above, and secured in the collapsed position with a bead 397.

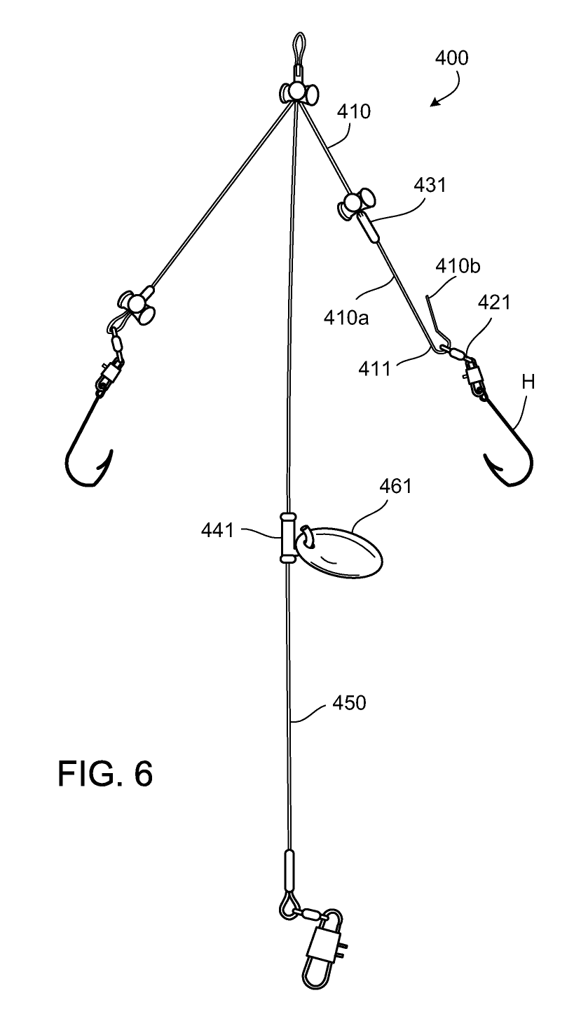

In some implementations, as illustrated in FIG. 6, a distal end 411 of an arm 410 of a rig 400 is releasable to allow convenient removal of a swivel 421 and/or a hook H. When desired, a sleeve 431 is disposed around both medial portion 410a and a distal portion 410b of the arm 410. The sleeve 431 can be crimped for more durable securing of an accessory within a loop of the distal end 411. Alternatively, friction may be relied on to secure the distal end 411 in a loop configuration to retain an accessory.

As also illustrated in FIG. 6, various other accessories can be included in the rig 400. For example, a releasable clasp 441 is included on a central leg 450. The hook 441 can slide along the central leg, and an accessory, such as a spinner 461 can be engaged with the clasp 441.

A number of embodiments of the claimed invention have been described. Nevertheless, it will be understood that various modifications may be made without departing from the spirit and scope of the claimed invention. For example, first member 110 may be fixedly engaged with second member 120, or first member 110 may be removably engaged with second member 120, such as by a threaded coupling or other releasable coupling. Additionally, while second member 120 has been described including loop 125 formed in medial portion 121b, loop 125 may be replaced by a loop formed in second end 115 of first member 110, and medial portion 121b may be joined to first member 110 at a location proximate to and medial of second end 115. Furthermore, a sleeve, a tie, a strap, a clip, or other fastening device may be substituted for, or used in conjunction with, the bead 197 in order to retain the rig 100 in the storage configuration illustrated in FIG. 1a. Accordingly, other embodiments are within the scope of the following claims.

What is claimed is:

1. A device for fishing in a body of water, the device comprising:
a first generally extended member having a first end and a second end, the second end operable with a first attachment;
a second member comprising a generally resilient material having a first portion connected with the first member and a second portion operable with a second fishing attachment, the second member being biased in a position angularly disposed relative to the first member; and
a sleeve slidably operable with the first member and the second member to retain the second member disposed proximate and generally in alignment with the first member.

2. The device of claim 1, wherein the second member comprises a first end, a second end, and a medial portion, the second end being biased in a position angularly disposed relative to the first member and adapted to be retained proximate and generally in alignment with the first member by the sleeve.

3. The device of claim 2, wherein the medial portion comprises a loop formed in the second member, and wherein the second member is fixedly connected with the first member proximate the loop and proximate the first end of the first member.

4. The device of claim 2, wherein a distance from the medial portion to the first end of the second member is unequal to a distance from the medial portion to the second end of the second member.

5. The device of claim 1, further comprising the second fishing attachment, and wherein the second fishing attachment is operable with the second member such that the second fishing attachment is prevented from engaging the first member when the second member is in the position angularly disposed relative to the first member.

6. The device of claim 1, wherein the first member comprises a joint at a proximal portion thereof, the first member operable to fold about the joint.

7. A fishing rig comprising:
a first wire member having a first end and a second end;
at least one arm connected to the first member proximate the first end of the first member, the at least one arm adapted to receive a fishing implement on a distal end thereof; and
a sleeve disposed around the first wire member,
wherein the arm is collapsible for storage, the distal end is spaced from the first member when the arm is not collapsed, and the sleeve is disposed around the arm to retain the arm in a collapsed position.

8. The fishing rig of claim 7, wherein the at least one arm comprises a first portion and a second portion, the first portion having a length unequal to a length of the second portion.

9. The fishing rig of claim 7, wherein the first wire member comprises a medial hinge.

10. A method of making a fishing rig comprising:
forming a loop in a medial portion of a first generally resilient wire member; and
securing a first end of a second generally resilient wire member to the first member proximate the loop,
wherein the second member depends from the loop, and wherein a first end and a second end of the first member are disposed spaced from one another and spaced from the second member.

11. The method of claim 10, further comprising hingedly securing a third member to the second member proximate a second end of the second member.

12. The method of claim 10, further comprising disposing a sleeve surrounding the first member and the second member.

13. The method of claim 12, wherein the disposing comprises sliding the sleeve over the first end and the second end of the first member, and further comprising bending the first member to dispose the first end and the second end spaced from one another after the sliding.

14. A method of using a fishing rig having at least one collapsible arm secured to and extending generally laterally from a first member, the method comprising:
collapsing the at least one collapsible arm to dispose the at least one arm proximate and generally parallel to the first member; and
sliding a collar over the at least one collapsible arm and the first member to retain the at least one collapsible arm proximate and generally parallel to the first member.

15. The method of claim 14, further comprising releasing the at least one collapsible arm from proximate and generally parallel to the first member by sliding the collar over the at least one collapsible arm and the first member.
